(19) United States
(12) Patent Application Publication
(10) Pub. No.: US 2012/0281424 A1
(43) Pub. Date: Nov. 8, 2012

(54) ILLUMINATION LAMP WITH DUAL BEAM FUNCTIONS

(75) Inventors: John Alexander Hansen, Kansas City, MO (US); Nathan Thomas Taylor, Lee's Summit, MO (US); Donald M. Lane, Lee's Summit, MO (US)

(73) Assignee: PETERSON MANUFACTURING COMPANY, Grandview, MO (US)

(21) Appl. No.: 13/462,049

(22) Filed: May 2, 2012

Related U.S. Application Data
(60) Provisional application No. 61/481,529, filed on May 2, 2011.

(51) Int. Cl. B60Q 1/16; F21V 13/04; F21V 31/03; F21V 7/06

(52) U.S. Cl. 362/517

(57) ABSTRACT

Implementations described and claimed herein provide a dual function illumination lamp in compliance with regulations for vehicular forward lighting. In one implementation, the illumination lamp includes a first reflector and a second reflector. The first reflector has a first reflecting region adapted to reflect light emitted from a first light emitting diode through an optics-free lens. The light reflected from the first reflecting region forms a first beam light pattern. The second reflector has a second reflecting region adapted to reflect light emitted from a second light emitting diode through the optics-free lens. The light reflected from the second reflecting region forms a second beam light pattern that is different from the first beam light pattern. In some implementations, the first beam light pattern is a low beam light pattern, and the second beam light pattern is a high beam light pattern.

### CROSS-REFERENCE TO RELATED APPLICATIONS

The present application claims benefit of priority to U.S. Provisional Patent Application No. 61/481,529, entitled “LED Headlamp with Low and High Beam” and filed on May 2, 2011, which is specifically incorporated by reference herein in its entirety.

### BACKGROUND

Many vehicles include one or more illumination lamps to provide visibility in reduced lighting conditions (e.g., at night, during precipitation, etc.). Various regulations, such as U.S. Department of Transportation federal regulations, apply to such lamps to ensure the lamps do not cause, for example, glare, poor contrast, or poor visibility. For example, many regulations require a lamp system to produce a low beam and a high beam.

Vehicular illumination lamps utilize various types of light sources to form beam of lights in compliance with such regulations. One such light source is a light emitting diode (LED). However, many lamps utilizing LED's are overly complex, expensive, and suffer from logistical problems. For example, these lamps often include a high number of light sources (e.g., five to seven light sources) in one lamp. Further, many of these lamps utilize a combination of lens optics and reflector optics to form a beam of light, which complicates and/or reduces the efficiency of light collection and distribution.

### BRIEF SUMMARY

Implementations described and claimed herein address the foregoing problems by providing an illumination lamp adapted to efficiently produce a high beam light pattern and a low beam light pattern in compliance with federal regulations for vehicular forward lighting. In one implementation, the illumination lamp includes a first reflector and a second reflector. The first reflector has a first reflecting region adapted to reflect light emitted from a first light emitting diode through an optics-free lens. The light reflected from the first reflecting region forms a first beam light pattern. The second reflector has a second reflecting region adapted to reflect light emitted from a second light emitting diode through the optics-free lens. The light reflected from the second reflecting region forms a second beam light pattern that is different from the first beam light pattern. In some implementations, the first beam light pattern is a low beam light pattern, and the second beam light pattern is a high beam light pattern. In other implementations, the first beam light pattern and the second light beam pattern form a third light beam pattern.

Other implementations are also described and recited herein. Further, while multiple implementations are disclosed, still other implementations of the presently disclosed technology will become apparent to those skilled in the art from the following detailed description, which shows and describes illustrative implementations of the presently disclosed technology. As will be realized, the presently disclosed technology is capable of modifications in various aspects, all without departing from the spirit and scope of the presently disclosed technology. Accordingly, the drawings and detailed description are to be regarded as illustrative in nature and not limiting.

### BRIEF DESCRIPTION OF THE DRAWINGS

FIG. 1 illustrates a side elevation view of an implementation of a vehicular illumination lamp.

FIG. 2 illustrates a front elevation view of the vehicular illumination lamp with the lens decoupled.

FIG. 3 illustrates a front view of the vehicular illumination lamp, except the lens is not shown.

FIG. 4 illustrates a front view of an example implementation of a high beam reflector and a low beam reflector of the vehicular illumination lamp.

FIG. 5 illustrates an enlarged, cross-sectional view of FIG. 4.

FIGS. 6A and 6B illustrate elevation views of an implementation of a first reflector shelf and a second reflector shelf of the vehicular illumination lamp, respectively.

FIG. 7 illustrates a side elevation view of an implementation of a first reflector, a divider, and a second reflector decoupled.

FIG. 8 illustrates an exploded view of an implementation of the vehicular illumination lamp.

FIG. 9 illustrates an enlarged view an implementation of a housing of the vehicular illumination lamp.

FIG. 10 illustrates a side elevation view of an implementation of the second reflector.

FIG. 11 illustrates a side elevation view of an implementation of the first reflector.

FIG. 12 illustrates a side elevation view of an implementation of a reflector divider decoupled from a light source of the vehicular illumination lamp.

FIG. 13 illustrates a side elevation view of an implementation of a reflector divider coupled to a light source of the vehicular illumination lamp.

### DETAILED DESCRIPTION

Aspects of the presently disclosed technology involve a dual function light emitting diode (LED) vehicular illumination lamp. In one example implementation, the lamp is adapted to utilize reflector optics to provide a low beam light pattern from a first LED in a low beam function and a high beam light pattern from a second LED in a high beam function. Generally, the high beam light pattern maximizes seeing distance by providing a light distribution pattern that is a relatively higher intensity and centrally concentrated. The low beam light pattern provides forward and lateral illumination while reducing glare. In some implementations, the high beam light pattern is generally symmetrical and the low beam light pattern is generally asymmetrical. The lamp may switch between the high beam function and the low beam function manually or automatically. Further, in some implementations, when the lamp is operating in the high beam function, the lamp may further produce the low beam light pattern, at full or partial power, to provide additional light for increased visibility.

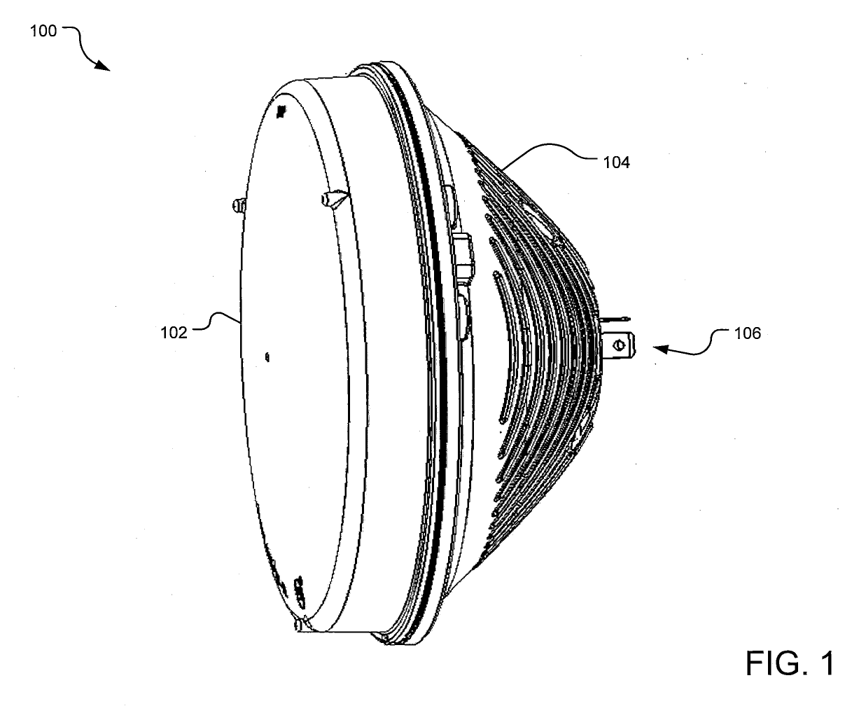

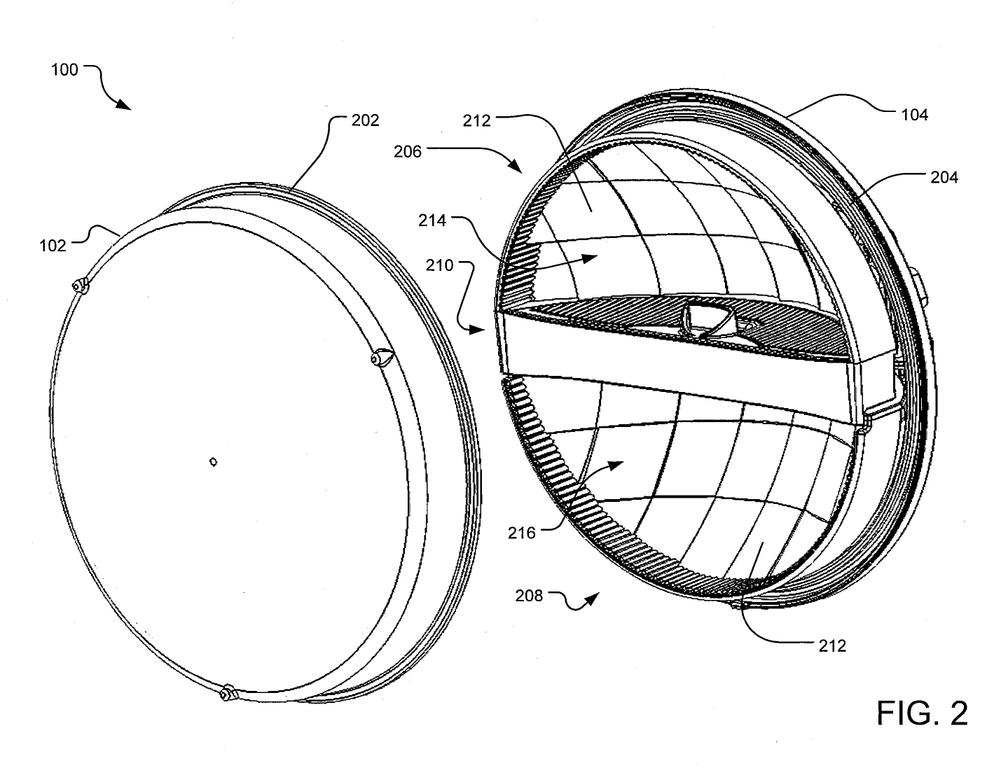

For a detailed discussion of an implementation of the vehicular illumination lamp, reference is made to FIG. 1, which is a side elevation view. As shown in FIG. 1, the lamp 100 includes a lens 102. In one implementation, the lens 102 is optics free, such that the lens 102 does not substantially refract light emitted from the lamp 100 in the high beam function and/or the low beam function. The lens 102 is comprised of a light transmitting substance, including, without limitation, glass, thermoplastic polymers, or other plastics. For example, the lens 102 may be made from a hardcoated polycarbonate. The lens 102 may be a variety of shapes, including, without limitation, generally cylindrical, rectangular, conical, pyramidal, and other shapes that match the sculpting or contouring of the vehicle. Further, the lens 102 may be sized to cover one or more reflectors, as discussed with respect to FIG. 2. However, other shapes and sizes are contemplated.

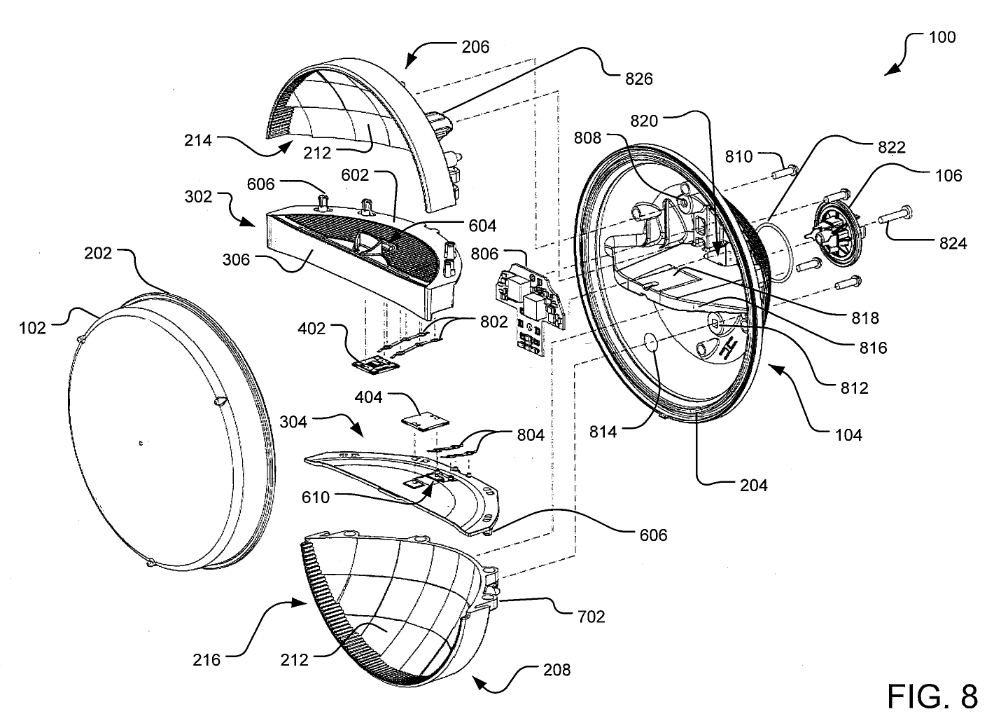

The lens 102 is coupled to a housing 104, which is comprised of a robust substance, including, but not limited to, a plastic or a metal (e.g., aluminum). The housing 104 may be a variety of shapes, such as generally conical, rectangular, cylindrical, pyramidal, etc. In one implementation, the shape of the housing 104 mirrors the shape of a cavity in a vehicle adapted to receive the lamp 100. The lamp 100 further includes an electrical connector 106 configured to provide power to the lamp 100 from the vehicle, as described herein, for example, with respect to FIG. 8.

As shown in FIG. 2, which depicts a front elevation view of the lamp 100 with the lens 102 decoupled from the housing 104, the lens 102 includes a cavity and a rim 202 that may be secured to a rim 204 of the housing 104, for example, using an adhesive or sealing compound to prevent moisture intrusion into lamp 100. As depicted in FIG. 2, the lamp 100 further includes a first reflector 206, a second reflector 208, and a divider 210, which are enclosed between the lens 102 and the housing 104 in the housing cavity.

The first reflector 206 and the second reflector 208 are configured to provide different beam functions. Specifically, the first reflector 206 has a first reflector region 214 adapted to produce a first beam light pattern, and the second reflector 208 has a second reflector region 216 adapted to produce a second beam light pattern different from the first beam light pattern. For example, the first reflector 206 may provide the low beam light pattern, and the second reflector 208 may provide the high beam light pattern, as described herein. The first reflector 206 or the second reflector 208 is illuminated to produce either the first beam light pattern or the second beam light pattern, respectively.

In some implementations, the lamp 100 may produce both the first beam light pattern and the second beam light pattern, each at full or partial power, to form a third beam light pattern. In such implementations, the first beam light pattern may be generally similar to or different from the second beam light pattern. Specifically, the lamp 100 illuminates the first and second reflectors 206 and 208 to produce the third beam light pattern, the characteristics of which may vary depending on visibility conditions and user needs. For example, the lamp 100 may be adapted to produce the third beam light pattern for a motorcycle forward auxiliary lamp. In other words, the first and second reflectors 206 and 208 are both illuminated to produce a forward auxiliary beam light pattern. In other implementations, the third beam light pattern is the high beam light pattern, as described herein. Specifically, the first and second reflectors 206 and 208 are illuminated, with the second beam light pattern and the first beam light pattern provided on substantially full or partial power. For example, to produce the high beam light pattern, the first and second beam light patterns may each be provided at partial power. Alternatively, to produce the high beam light pattern, the second beam light pattern may be provided at substantially full power and the first beam light pattern at partial power. In still other implementations, the lamp 100 may be a single function lamp, with a reflector being illuminated to provide a single beam light pattern (e.g., the high beam light pattern or the low beam light pattern).

In one implementation, the first and second reflector regions 214 and 216 include a plurality of reflecting surfaces 212 for directing light from a light source through the lens 102 in the first or second beam light pattern. The reflecting surfaces 212 may be generally smooth, angled surfaces, which are oriented to receive light from a light source and reflect the light to form a pattern of light, such as the high beam light pattern or the low beam light pattern. The reflecting surfaces 212 may be contoured to match the shape of the first reflector region 214 or the second reflector region 216.

In one implementation, the first and second reflectors 206 and 208 are each removably attached to the divider 210 and each have an arcuate shape, such as a partial hemispherical or hemi-elliptical shape. In another implementation, the first and second reflectors 206 and 208 are part of a single structure having a generally hemispherical or hemi-elliptical shape that is divided into two regions by the divider 210 to form the first and second reflectors 206 and 208. The first and second reflector regions 214 and 216 are comprised of a generally reflective substance, such as metal or plastic. In one implementation, the first and second reflector regions 214 and 216 are a plastic molding compound that is base-coated and vacuum metalized.

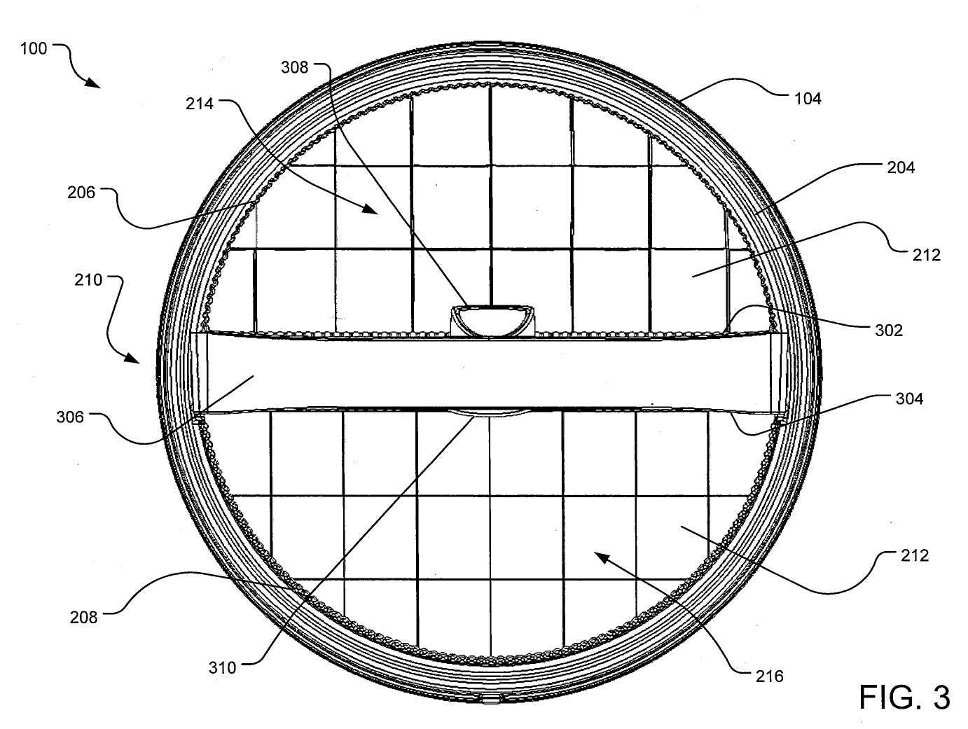

FIG. 3 illustrates a front view of the lamp 100, except the lens 102 is not shown. In one implementation, the divider 210 includes a first reflector shelf 302 and a second reflector shelf 304 that are separated by a divider face 306. The first and second reflector shelves 302 and 304 may include shields 308 and 310 to help prevent light from exiting the lamp 100 through the lens 102 without having first been reflected off the first or second reflector regions 214 and 216, respectively. Specifically, the shields 308 and 310 absorb light rays emitted directly from a light source that have not been reflected by the first or second reflector regions 214 and 216.

As will be appreciated, the divider 210 permits illumination to be separately received and reflected by the first reflector 206 or the second reflector 208 to provide different beam functions. In other words, during operation, the lamp 100 provides a first beam function (e.g., the low beam function) by illuminating the first reflector 206 and reflecting the light off the reflecting surfaces 212 on the first reflector region 214. Similarly, the lamp 100 provides a second beam function (e.g., the high beam function) by illuminating the second reflector 208 and reflecting the light off the reflecting surfaces 212 on the first reflector region 216. Additionally, the lamp 100 may produce a combination of the first and second beam functions, for example, to provide a third beam function. For example, while the lamp 100 is operating in the second beam function by illuminating the second reflector 208, the lamp 100 may also illuminate the first reflector 206, at full or partial power, to provide additional light. However, it will be understood by those of ordinary skill in the art, that the lamp 100 may produce other combinations of the first beam function and the second beam function, and the divider 210 may be adapted to divide the housing 104 such that the lamp 100 may achieve additional beam functions.

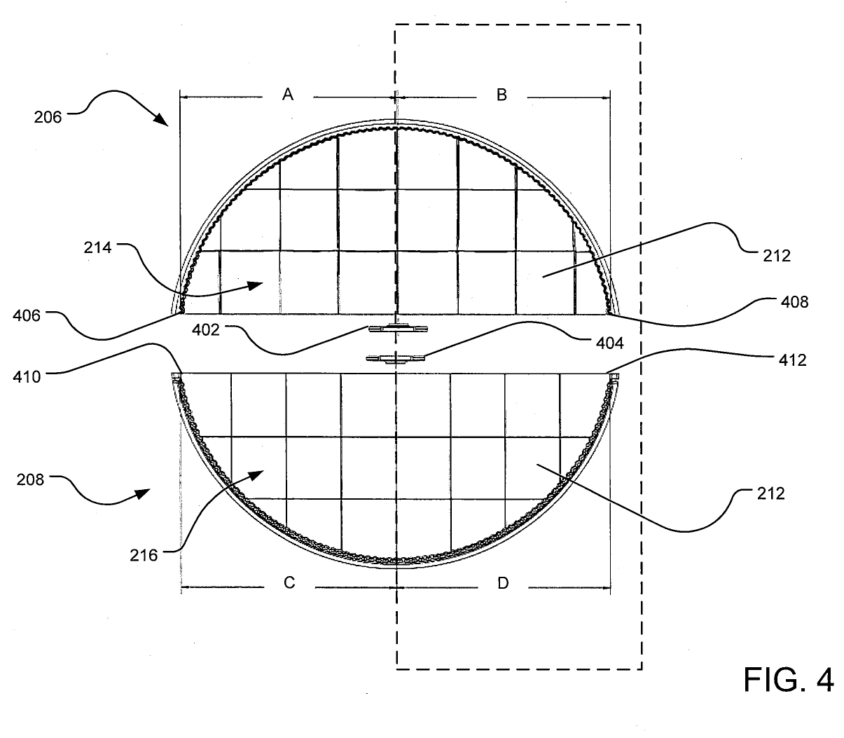

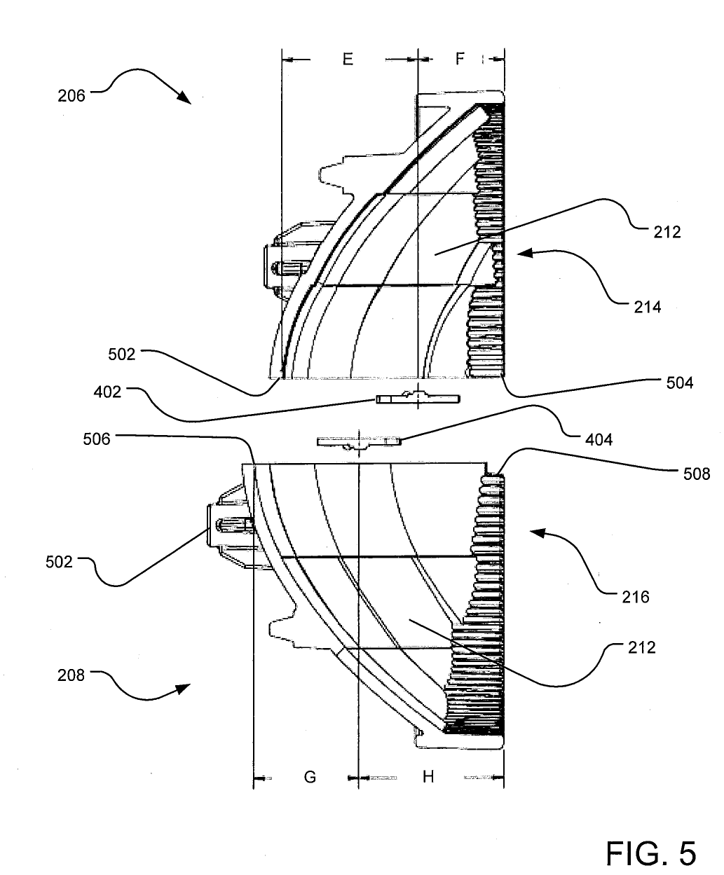

As can be understood from FIGS. 4-5, in one implementation, the first reflector 206 is a different shape and/or size than the second reflector 208 to produce different beam functions. FIG. 4 shows a front view of the first reflector 206 and the second reflector 208 of the lamp 100, and FIG. 5 is an enlarged, cross-sectional view of the portion of FIG. shown in dotted lines. In the example implementation illustrated in FIGS. 4-5, the first reflector 206 is adapted to provide the low beam function and the second reflector 208 is adapted to provide the high beam function. However, it will be appreciated that the lamp 100 may be adapted to provide other beam functions.

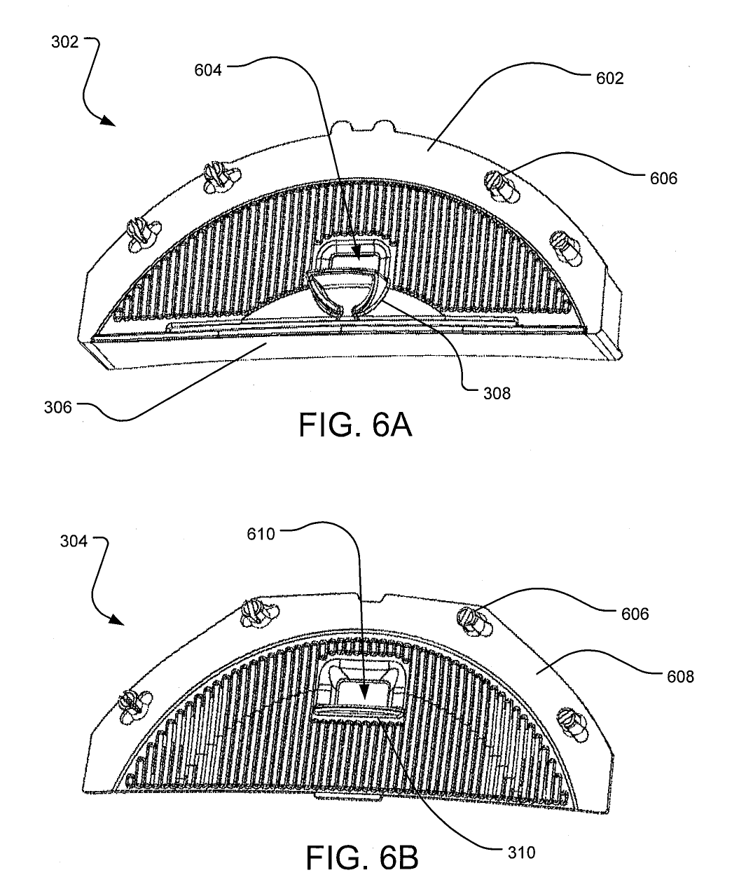

As described with respect to FIGS. 6A and 6B, in some implementations, a first LED 402 and a second LED 404 are positioned relative to apertures in the first and second reflector shelves 302 and 304, respectively, such that the first LED 402 directs light to the first reflector 206 and the second LED 404 directs light to the second reflector 208. In other implementations, the first LED 402 and the second LED 404 are positioned in the housing 104 relative to the first and second reflectors 206 and 208, respectively. It will be appreciated that in some implementations, while the first LED 402 and the second LED 404 are referred to as LED light sources, the first LED 402 and/or the second LED 404 may be other types of light sources, including without limitation, tungsten, tungsten-halogen, infrared, xenon, or some combination of them. Further, multiple LED's or other light sources may comprise each of the first LED 402 and/or the second LED 404.

The shape and dimensions of the first reflector 206 are adapted to produce the low beam light pattern, as described herein. In one implementation, a distance A from a first side edge 406 of the first reflector 206 to an axis of the first LED 402 is substantially the same as a distance B from a second side edge 408 of the first reflector 206 to the axis of the first LED 402, and a distance E from a back edge 502 of the first reflector 206 to the axis of the first LED 402 is different from a distance F from a front edge 504 of the first reflector 206 to the axis of the first LED 402. When assembled, the front edge 504 is disposed near the lens 102.

The similarities in the sizes of distance A and distance B and the differences in the sizes of distance E and distance F may be based, for example, on the regulatory requirements for the low beam light pattern. For example, the sizes may direct the low beam light pattern at the foreground in front of a vehicle such that light is not emitted higher than that allowed by federal regulations and direct the light away from oncoming traffic. In a specific exemplary implementation, the distance A is substantially the same as the distance B, and the distance E is greater than the distance F. For example, the distances A and/or B may range from approximately 2.950 inches to 3.050 inches, the distance E may range from approximately 1.250 inches to 1.365 inches, and the distance F may range from approximately 0.780 inches to 0.885 inches. In a specific example, the distance E is approximately 1.312 inches and the distance F is approximately 0.833 inches. However, other sizes and relative dimensions of distance A compared to distance B and distance E compared to distance F are contemplated depending, for example, on regulation requirements.

The shape and dimensions of the second reflector 208 are adapted to produce the high beam light pattern, as described herein. In one implementation, a distance C from a first side edge 410 of the second reflector 208 to an axis of the second LED 404 is substantially the same as a distance D from a second side edge 412 of the second reflector 208 to the axis of the second LED 404, and a distance G from a back edge 506 of the second reflector 208 to the axis of the second LED 404 is different from a distance H from a front edge 508 of the second reflector 208 to the axis of the second LED 404. When assembled, the front edge 508 is disposed near the lens 102.

The similarities in the sizes of distance C and distance D and the differences in the sizes of distance G and distance H may be based, for example, on the regulatory requirements for the high beam light pattern. For example, the sizes maximize seeing distance by providing a light distribution pattern that is a relatively higher intensity and centrally concentrated. In a specific exemplary implementation, the distance C is substantially the same as the distance D, and the distance G is less than the distance H. For example, the distances C and/or D may range from approximately 2.950 inches to 3.050 inches, the distance G may range from approximately 0.955 inches to 1.055 inches, and the distance H may range from approximately 1.350 inches to 1.455 inches. In a specific example, the distance G is approximately 1.005 inches and the distance F is approximately 1.402 inches. However, other sizes and relative dimensions of distance C compared to distance D and distance G compared to distance H are contemplated depending, for example, on regulation requirements.

FIGS. 6A and 6B illustrate elevation views of an implementation of the first reflector shelf 302 and the second reflector shelf 304 of the lamp 100, respectively. The first and second reflector shelves 302 and 304 may be made, for example, from nylon with glass fill. In one implementation, the first reflector shelf 302 includes a surface 602 having an aperture 604 defined therein and the divider face 306 connected to the surface 602. The second reflector shelf 304 includes a surface 608 having an aperture 610 defined therein.

The first LED 402 is positioned relative to the first reflector shelf aperture 604, and the second LED 404 is positioned relative to the second reflector shelf aperture 610. During operation, the first LED 402 emits light through the aperture 604 in the first reflector shelf 302, which is received and reflected by the first reflecting region 214 in the first reflector 206. Similarly, the second LED 404 emits light through the aperture 610 in the second reflector shelf 304, which is received and reflected by the second reflecting region 216 in the second reflector 208, as described herein. In one implementation, the shields 308 and 310 are positioned relative to the apertures 604 and 610 in the first and second reflector shelves 302 and 304, respectively, to absorb light rays emitted directly from the first LED 402 or the second LED 404 that have not been reflected by the first or second reflector regions 214 and 216. Specifically, the shields 308 and 310 may help prevent the first and second LED's 402 and 404 from emitting light through the lens 102 via the apertures 604 and 610 directly, without having first been reflected off the first or second reflector regions 214 and 216.

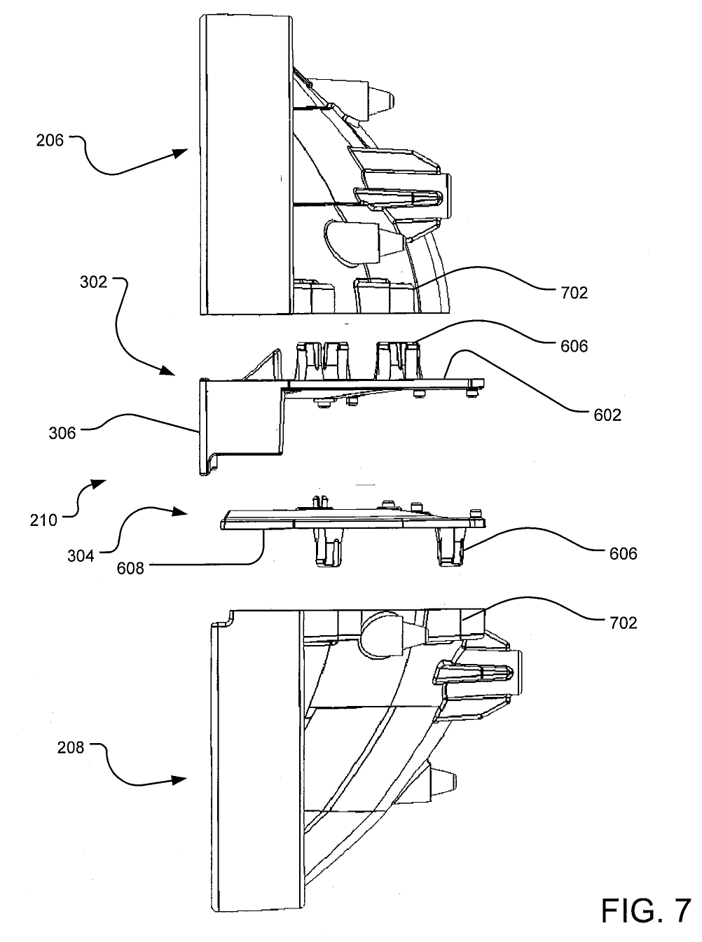

In one implementation, the first and second reflector shelves 302 and 304 include one or more mounting members 606 configured to engage the first and second reflectors 206 and 208, respectively, as shown best in FIG. 7, which is a side elevation view of the first and second reflectors 206 and 208 decoupled. Specifically, the first and second reflectors 206 and 208 each include engaging portions 702 adapted to receive and engage the mounting members 606 on the first and second reflector shelves 302 and 304. The divider face 306 of the first reflector shelf 302 may then be positioned relative to the second reflector shelf 304 such that the first and second reflectors 206 and 208 and the divider 210 may be inserted into the housing 104, as illustrated in FIG. 8.

As can be understood from FIG. 8, which is an exploded view of an implementation of the lamp 100, the electrical connector 106 is in electrical communication with the first and second LED's 402 and 404 via a circuit board 806, which converts electrical energy received from the electrical connector 106 to a specific current for selectable illumination of the first LED 402 and/or the second LED 404. In other words, the circuit board 806 converts electrical energy received from an electrical system of the vehicle via the electrical connector 106 to a generally constant, controlled current, which allows the voltage supplied to the first and second LED's 402 and 404 to float, as needed, to maintain a specific current required to illuminate the first and second LED's 402 and 404. In one implementation, the circuit board 806 is in electrical communication with the first and second LED's 402 and 404 via first and second leads 802 and 804, respectively. The first and second leads 802 and 804 are made from an electrically conductive material, including, without limitation, metal (e.g., brass). Further, the first and second LED's 402 and 404 may each be mounted on a chip made from a thermally conductive material (e.g., aluminum), which draws heat from the first LED 402 or the second LED 404. To further help facilitate heat transfer, a thermally conductive foam may be applied to one or more surfaces of the circuit board 806, and a thermally conductive grease (e.g., a silicone based composition) may be applied to one or more surfaces of the first and second LED's 402 and 404.

The circuit board 806 is configured to receive and/or execute commands to illuminate the first LED 402 and/or the second LED 404 at full or partial power, as well as commands to turn off the first LED 402 and/or the second LED 404. In other words, the first LED 402 and the second LED 404 may be selectively illuminated to form the first beam light pattern and/or the second beam light pattern. In some implementations, a user (e.g., a driver of the vehicle) manually selects the first beam function and/or the second beam function, and in response to the command, the first LED 402 and/or the second LED 404 are illuminated. In other implementations, the circuit board 806 automatically executes commands to illuminate the first LED 402 and/or the second LED 404 in response to lighting and visibility conditions. For example, the lamp 100 may include one or more sensors to determine when darker lighting conditions are present and automatically illuminate the first LED 402 and/or the second LED 404, accordingly. In still other implementations, a third beam light pattern may be formed by illuminating the first LED 402 and the second LED 404, together, at full or partial power. For example, the third beam light pattern may be produced by illuminating the second LED 404 at substantially full power and the first LED 402 at partial power.

In one implementation, the electrical connector 106 is connected to the circuit board 806 through an opening 820 in the housing 104. The electrical connector 106 engages the housing 104, for example, with a mounting screw 824 and a ring 822, which provides a seal between the electrical connector 106 and the housing 104. The ring 822 may be, for example, a silicone O-ring.

The first and second reflectors 206 and 208 are connected to the housing 104, for example, by inserting one or more mounting screws 810 through openings 808 in the housing 104 to engage with one or more channels 826 on the first and second reflectors 206 and 208. In a specific example implementation, four mounting screws 810 are inserted through four openings 808 to engage with two channels 826 in the first reflector 206 and with two channels 826 in the second reflector 208. However, other amounts and additional mounting mechanisms are contemplated.

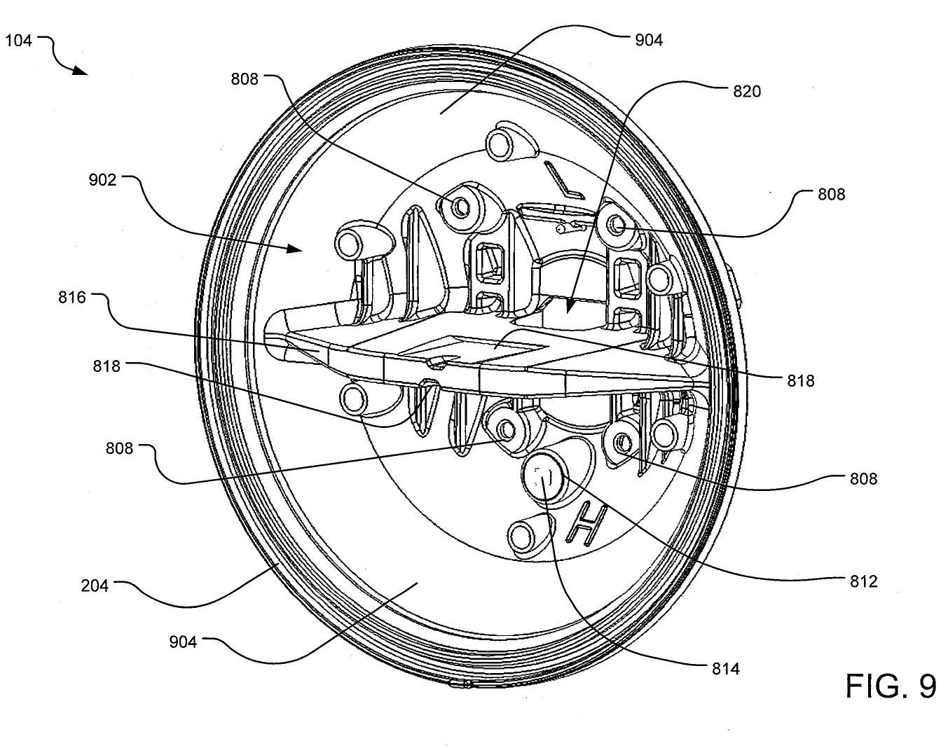

As can be understood from FIGS. 8 and 9, in one implementation, when the lamp 100 is assembled, a shelf 816 in the housing 104 is disposed between the first and second reflector shelves 302 and 304 behind the divider face 306. The housing shelf 816 includes one or more slots (e.g., slot 818) that are adapted to receive the first LED 402 and/or the second LED 404. The slots 818 are positioned on the housing shelf 816 such that the first and second LED's 402 and 404 are posited relative to the apertures 604 and 610 in the first and second reflector shelves 302 and 304, respectively. It will be appreciated that the slots 818 and/or the first and second LED's 402 and 404 may be positioned at other locations within the housing 104. For example, the first and second LED's 402 and 404 may be disposed on an interior surface 904 in the cavity 902 of the housing 104, and the first and second reflecting regions 214 and 216 may be oriented relative to the positions of the first and second LED's 402 and 404, respectively.

In one implementation, the housing 104 includes an aperture 812, which may be covered by a breathable membrane 814. FIG. 8 shows the breathable membrane 814 decoupled from the aperture 812, and FIG. 9 shows the breathable membrane 814 covering the aperture 812. The breathable membrane 814 permits gas exchange from the interior of the lamp 100 and the outside atmosphere to equalize the pressure between the interior of the lamp 100 and the outside atmosphere. For example, during operation, the lamp 100 generates heat, which causes the pressure inside the lamp 100 to increase relative to the pressure of the outside atmosphere. Such pressure differentials may result in malfunction of the lamp 100. The breathable membrane 814 equalizes the pressures, while preventing moisture intrusion into the interior of the lamp 100.

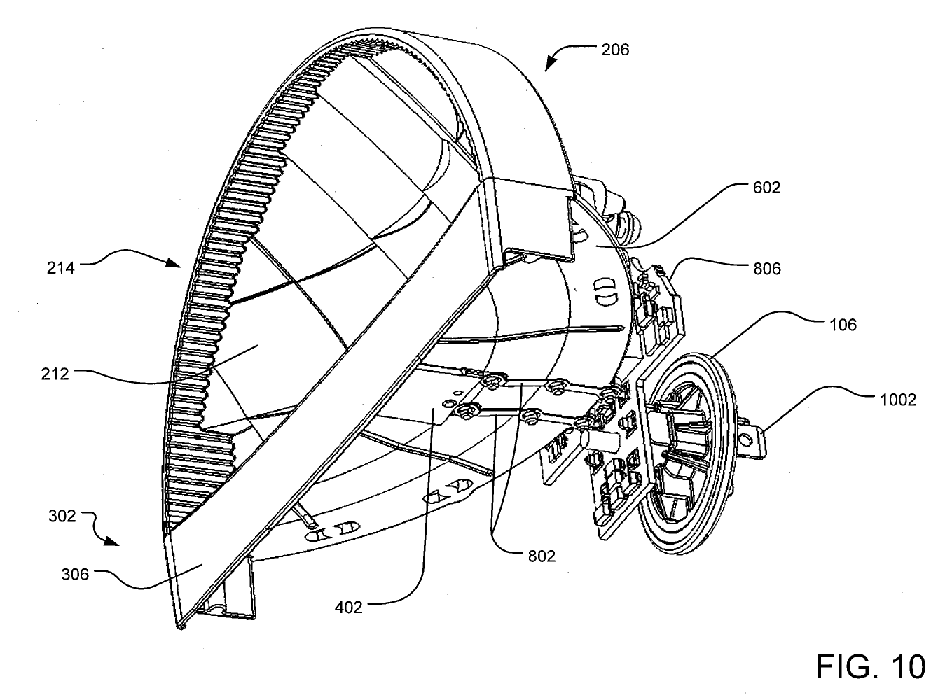

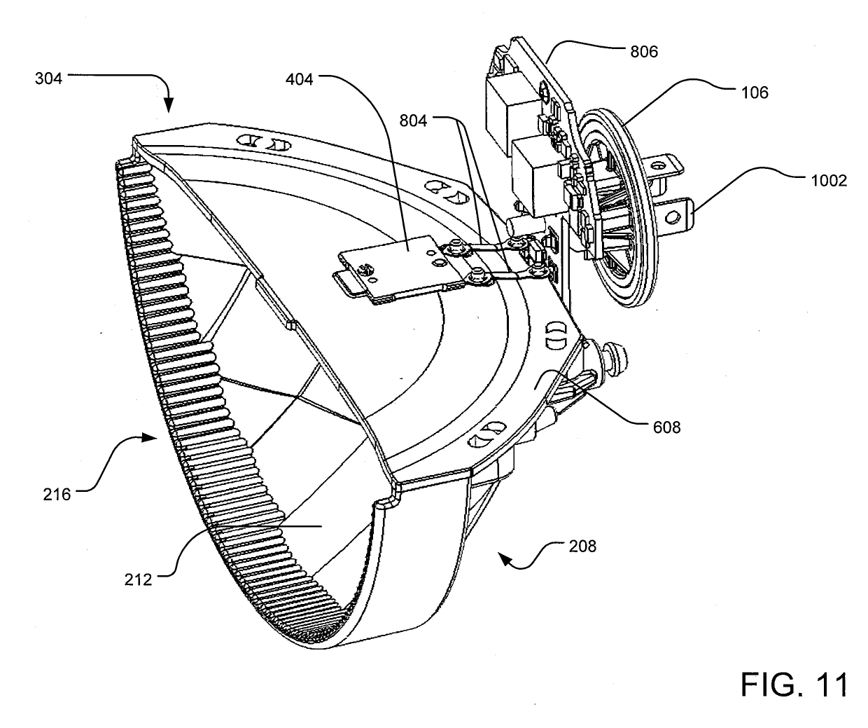

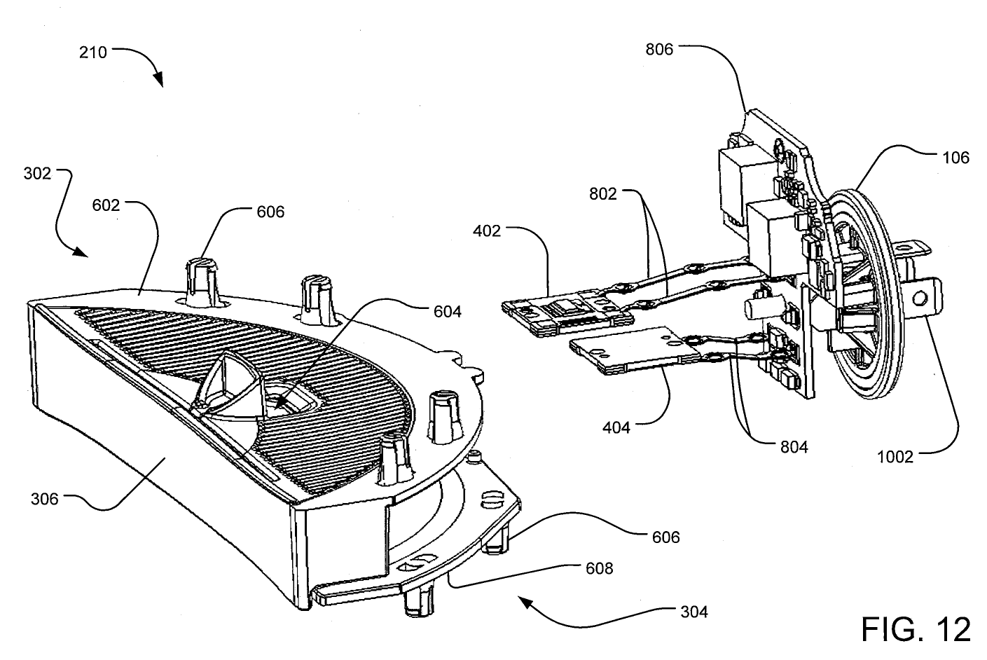

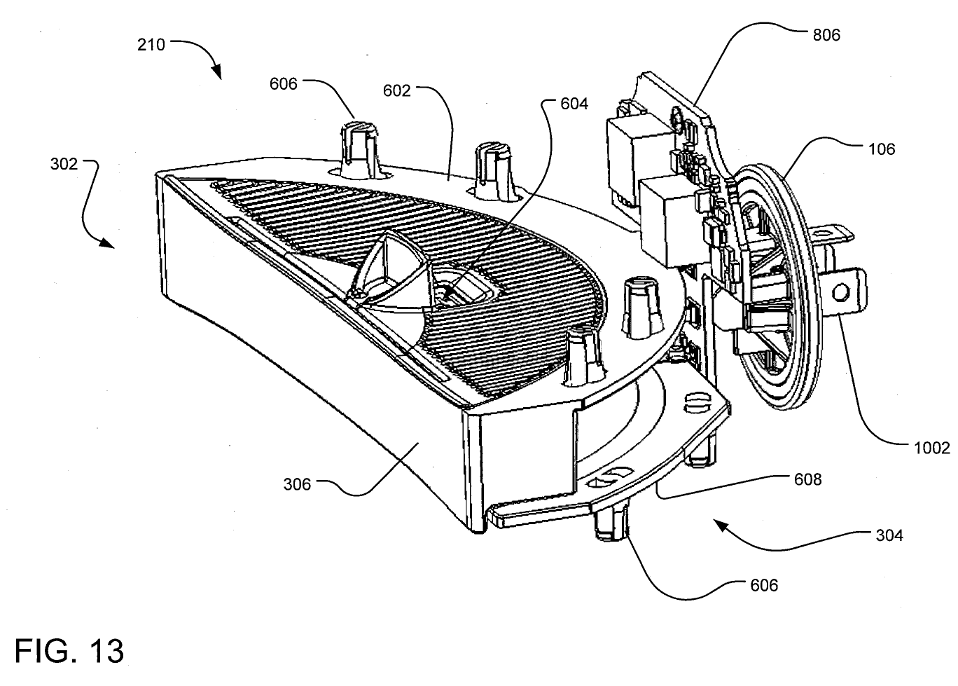

As can be understood from FIGS. 10-13, in one implementation, the first and second LED's 402 and 404 are positioned between the first and second reflector shelves 302 and 304 behind the divider face 306 relative to the apertures 604 and 610, respectively. The positioning of the first and second LED's 402 and 404 permits selective illumination of the first reflector 206 and/or the second reflector 208. In other words, the first and second reflector shelves 302 and 304 prevent light from the first LED 402 from being reflected by the second reflecting region 216 and prevent light from the second LED 404 from being reflected by the first reflecting region 214. For example, if the first LED 402 is illuminated, the divider face 306 and the first and second reflector shelves 302 and 304 prevent light from being emitted from the interior of the lamp 100 except through the aperture 604.

The first LED 402 is in electrical communication with the circuit board 806 via the leads 802. In one implementation, the leads 802 are mounted on the surface 602 of the first reflector shelf 302 to position the first LED 402. In another implementation, the leads 802 are mounted on the housing shelf 816. The first LED 402 is positioned to direct light into the first reflector 206 through the aperture 604. The reflecting surfaces 212 redirect the light from various angles to form the first beam light pattern (e.g., the low beam light pattern).

Similarly, the second LED 404 is in electrical communication with the circuit board 806 via the leads 804. In one implementation, the leads 804 are mounted on the surface 608 of the second reflector shelf 304 to position the second LED 404. In another implementation, the leads 804 are mounted on the housing shelf 816. The second LED 404 is positioned to direct light into the second reflector 208 through the aperture 610. The reflecting surfaces 212 redirect the light from various angles to form the second beam light pattern (e.g., the high beam light pattern).

The circuit board 806 is in electrical communication with the electrical connector 106 to power the first and second LED's 402 and 404. As shown in FIGS. 10-13, in one implementation, the electrical connector 106 is an electrical plug having one or more terminals 1002. The electrical plug may be made, for example, from a plastic, and the terminals 1002 may be insert-molded terminals made from an electrically conductive material, including, without limitation, a tin coated brass.

All directional references (e.g., proximal, distal, upper, lower, upward, downward, left, right, lateral, front, back, top, bottom, above, below, vertical, horizontal, clockwise, counterclockwise, etc.) are only used for identification purposes to aid the reader's understanding of the presently disclosed technology, and do not create limitations, particularly as to the position, orientation, or use of any of the implementations. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. The exemplary drawings are for purposes of illustration only and the dimensions, positions, order and relative sizes reflected in the drawings attached hereto may vary.

Various modifications and additions can be made to the exemplary embodiments discussed without departing from the spirit and scope of the presently disclosed technology. For example, while the embodiments described above refer to particular features, the scope of this disclosure also includes embodiments having different combinations of features and embodiments that do not include all of the described features. Accordingly, the scope of the presently disclosed technology is intended to embrace all such alternatives, modifications, and variations together with all equivalents thereof.

What is claimed is:

1. A vehicular illumination lamp comprising:
a first reflector having a first reflecting region adapted to reflect light emitted from a first light emitting diode through an optics-free lens, the light reflected from the first reflecting region forming a first beam light pattern; and
a second reflector having a second reflecting region adapted to reflect light emitted from a second light emitting diode through the optics-free lens, the light reflected from the second reflecting region forming a second beam light pattern that is different from the first beam light pattern.

2. The vehicular illumination lamp of claim 1, wherein the first beam light pattern is a low beam light pattern and the second beam light pattern is a high beam light pattern.

3. The vehicular illumination lamp of claim 1, wherein the first reflector region comprises a plurality of reflecting surfaces oriented relative to the first light emitting diode to reflect light emitted from the first light emitting diode into the first beam light pattern.

4. The vehicular illumination lamp of claim 1, wherein the second reflector region comprises a plurality of reflecting surfaces oriented relative to the second light emitting diode to reflect light emitted from the second light emitting diode into the second beam light pattern.

5. The vehicular illumination lamp of claim 1 further comprising:
a first reflector shelf having a first aperture, the first light emitting diode being positioned relative to the first aperture such that light emitted from the first light emitting diode is directed into the first reflector; and
a second reflector shelf having a second aperture, the second light emitting diode being positioned relative to the second aperture such that light emitted from the second light emitting diode is directed into the second reflector, wherein the first reflector shelf prevents light emitted from the second light emitting diode from being reflected by the first reflector region and the second reflector shelf prevents light emitted from the first light emitting diode from being reflected by the second reflector region.

6. The vehicular illumination lamp of claim 1, wherein the first reflector has a first arcuate shape and the second reflector has a second arcuate shape that is different from the first arcuate shape.

7. The vehicular illumination lamp of claim 1, wherein a first distance from a first side edge of the first reflector to an axis of the first light emitting diode is substantially the same as a second distance from a second side edge of the first reflector to the axis of the first light emitting diode, and a third distance from a back edge of the first reflector to the axis of the first light emitting diode is greater than a fourth distance from a front edge of the first reflector to the axis of the first light emitting diode.

8. The vehicular illumination lamp of claim 1, wherein a first distance from a first side edge of the second reflector to an axis of the second light emitting diode is substantially the same as a second distance from a second side edge of the second reflector to the axis of the second light emitting diode, and a third distance from a back edge of the second reflector to the axis of the second light emitting diode is less than a fourth distance from a front edge of the second reflector to the axis of the second light emitting diode.

9. The vehicular illumination lamp of claim 1, wherein light reflected from the first reflecting region and the second reflecting region form a third beam light pattern.

10. The vehicular illumination lamp of claim 9, wherein the third beam light pattern is formed by illuminating the second light emitting diode at substantially full power and illuminating the first light emitting diode at partial power.

11. The vehicular illumination lamp of claim 9, wherein the third beam light pattern is formed in response to a command to illuminate the first light emitting diode and the second light emitting diode.

12. The vehicular illumination lamp of claim 1, wherein the first beam light pattern is formed in response to a command to illuminate only the first light emitting diode.

13. The vehicular illumination lamp of claim 1, wherein the second beam light pattern is formed in response to a command to illuminate only the second light emitting diode.

14. The vehicular illumination lamp of claim 1, wherein the first light emitting diode and the second light emitting diode may be selectively illuminated to form the first beam light pattern or the second beam light pattern.

15. A vehicular illumination lamp comprising:
a housing having a cavity, the housing being connected to an optics-free lens to cover the cavity;
a first reflector disposed within the cavity, the first reflector having a first reflecting region adapted to reflect light emitted from a first light emitting diode through the optics-free lens, the light reflected from the first reflecting region forming a first beam light pattern;
a second reflector disposed within the cavity, the second reflector having a second reflecting region adapted to reflect light emitted from a second light emitting diode through the optics-free lens, the light reflected from the second reflecting region forming a second beam light pattern; and
a divider disposed between the first reflector and the second reflector, the divider having a first aperture in a first reflector shelf and a second aperture in a second reflector shelf, wherein the first light emitting diode is positioned between the first reflector shelf and the second reflector shelf relative to the first aperture such that light emitted from the first light emitting diode is directed into the first reflector and the second light emitting diode is positioned between the first reflector shelf and the second reflector shelf relative to the second aperture such that light emitted from the second light emitting diode is directed into the second reflector.

16. The vehicular illumination lamp of claim 15, wherein the first reflector shelf prevents light emitted from the second light emitting diode from being reflected by the first reflector region and the second reflector shelf prevents light emitted from the first light emitting diode from being reflected by the second reflector region.

17. The vehicular illumination lamp of claim 15, wherein the first beam light pattern is a low beam light pattern and the second beam light pattern is a high beam light pattern.

18. The vehicular illumination lamp of claim 15, wherein the housing includes a breathable membrane adapted to permit gas exchange and to prevent moisture intrusion.

19. A vehicular illumination lamp comprising:
a first reflecting region adapted to reflect light emitted from a first light emitting diode through an optics-free lens, the light reflected from the first reflecting region forming a first beam light pattern;
a second reflecting region adapted to reflect light emitted from a second light emitting diode through the optics-free lens, the light reflected from the second reflecting region forming a second beam light pattern that is different from the first beam light pattern; and
a divider disposed between the first reflecting region and the second reflecting region, the divider being adapted to prevent light from the first light emitting diode from being reflected by the second reflecting region and to prevent light from the second light emitting diode from being reflected by the first reflecting region.

20. The vehicular illumination lamp of claim 19, wherein the first beam light pattern is a low beam light pattern and the second beam light pattern is a high beam light pattern.
